(19) United States
(12) Patent Application Publication
(10) Pub. No.: US 2020/0387559 A1
(43) Pub. Date: Dec. 10, 2020

(54) METHOD AND SYSTEM FOR AN APP TO MAKE FRIENDS AND FIND HOUSING WHEN MOVING TO A NEW CITY

(71) Applicant: Sharine Flynn, Paxton, MA (US)

(72) Inventor: Sharine Flynn, Paxton, MA (US)

(21) Appl. No.: 16/431,721

(22) Filed: Jun. 4, 2019

(51) Int. Cl. G06F 16/9535; G06F 16/9537; G06F 3/0482

(52) U.S. Cl. CPC G06F 16/9535; G06Q 30/0645; G06F 3/0482; G06F 16/9537

(57) ABSTRACT

An app that will allow people to be matched up based on common interests to become friends. The Friend App may be used by people who move to new places and don't know anyone, people who have friends that are always occupied and can't be around to do things, by someone who just wants another friend, by someone who wants to develop new interests and want to share them with someone, or by people who have trouble making friends just by daily activities.

### BACKGROUND OF THE INVENTION

### 1. Field of the Invention

The present invention relates generally to the field of mobile applications (apps) and more specifically relates to Friend App.

### 2. Description of the Related Art

A mobile app is a computer program designed to run on smartphones, tablet computers and other mobile devices. Mobile apps were originally offered for general productivity and information retrieval, including email, calendar, contacts, and stock market and weather information. The explosion in number and variety of apps made discovery a challenge, which in turn led to the creation of a wide range of review, recommendation, and curation sources, including blogs, magazines, and dedicated online app-discovery services. Many new apps are desirable to provide convenient solutions to the users.

Various attempts have been made to solve the problems that may be found in the related art but have thus far been unsuccessful. A need exists for a reliable the Friend App mobile application to avoid the above-mentioned problems.

### BRIEF SUMMARY OF THE INVENTION

In view of the foregoing disadvantages inherent in the known mobile app art, the present invention provides a novel app, named Friend App. The general purpose of the present invention, which will be described subsequently in greater detail, is to provide a hybrid App designed to help its users find friends with the same interest and activities when moving to a new place. The Friend App may be used by people who move to new places and don't know anyone, people who have friends that are always occupied and can't be around to do things, by someone who just wants another friend, by someone who wants to develop new interests and want to share them with someone, or by people who have trouble making friends just by daily activities. The survey questions answered by the users while creating an account in the app allows finding the best profile matches based on similar interests. The Housing feature facilitates the user to view the profile and details of other users who are willing to rent their facility. The Chat feature allows them to exchange text, images and smileys.

The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Friend App, constructed and operative according to the teachings of the present invention.

FIG. 1 shows a high-level workflow diagram for the Friend App according to an embodiment of the presently claimed invention.

FIG. 2 shows an example of the splash page according to an embodiment of the presently claimed invention.

FIG. 3 shows an example of the login page according to an embodiment of the presently claimed invention.

FIG. 4 shows an example of the sign up page according to an embodiment of the presently claimed invention.

FIG. 5 shows an example of the survey page according to an embodiment of the presently claimed invention.

FIG. 6 shows an example of the housing information page according to an embodiment of the presently claimed invention.

FIG. 7 shows an example of the home screen page for friends according to an embodiment of the presently claimed invention.

FIG. 8 shows an example of the home screen page for housing according to an embodiment of the presently claimed invention.

FIG. 9 shows an example of a profile screen for a user according to an embodiment of the presently claimed invention.

FIG. 10 shows an example of the home screen page for chat according to an embodiment of the presently claimed invention.

FIG. 11 shows an example of an individual chat screen between two users according to an embodiment of the presently claimed invention.

FIG. 12 shows an example of the settings page according to an embodiment of the presently claimed invention.

FIG. 13 shows an example of the blocked users page according to an embodiment of the presently claimed invention.

FIG. 14 shows an example of the terms and conditions page according to an embodiment of the presently claimed invention.

The various embodiments of the present invention will hereinafter be described in conjunction with the appended drawings.

### DETAILED DESCRIPTION

As discussed above, embodiments of the present invention relate to a mobile app and more particularly to a Friend App.

The Friend App is a novel product offering consumers a practical solution to the aforementioned challenges. As the name implies, the Friend App is an app that will allow people to be matched up based on common interests to become friends, as an alternative to the dating apps that are the only apps currently available to meet new people. The Friend App may be used by people who move to new places and don't know anyone, people who have friends that are always occupied and can't be around to do things, by someone who just wants another friend, by someone who wants to develop new interests and want to share them with someone, or by people who have trouble making friends just by daily activities. Users can be matched up to people by interests to find people with mutual interests and find people who are a good fit. To start a user may fill out a survey and the software would generate a profile for them and connect other users to them based on similar interests and hobbies. The Friend App uses each user's smartphone to collect information regarding their interests and housing, stores that information on a centralized server, performs a comparison algorithm to match users based on interests, and then relays the match information to each user's smartphone.

### Login Setup

Username and email, or connect via Facebook
Profile set up, profiles are private to only other users
Picture, name, age, location (desired location if moving)-short view
About me: User writes anything they want in a text box
Hobbies and Interests: using keywords to connect, such as Photography to connect users who also have input Photography as a hobby, user can create new Hobby and Interest Keywords
Occupation: Keyword linked as well, like Carpenter
Gallery where users can upload pics

### Survey

Activity Budget: S, SS, SSSS, DIY, at home
Check boxes, kids Y/N, dog Y/N, cat Y/N, weekend travel Y/N, etc
Looking for playdates with kids Y/N
Looking for playdates with pets Y/N
Are you a nightlife person Y/N
What time of day are you free? Morning, afternoon, night
What age range your looking for 15-20, 20-25, in 5 year increments, select all that apply
Subsection for Roommate seeking, opens up a menu of options, looking for housing, or looking for roommate in your housing, are you okay with living with pets, allergies, smoking etc.

### Match View

View profiles of people you matched with % of compatibility listed in short view
Another tabbed view to see all the users in your area, Filter by compatibility, distance, age, activity (active vs inactive users) in ascending order
Another tabbed view of just people looking for roommates, ‘house’ icon added to those profiles

### View Profile

See name, photo, age, sex, distance, compatibility percentile

### About me,

### Interests,

### Photos

Message button

### Occupations

### Pets

### Kids

### Messenger

Chat window, text, emojis, attach pictures and gifs

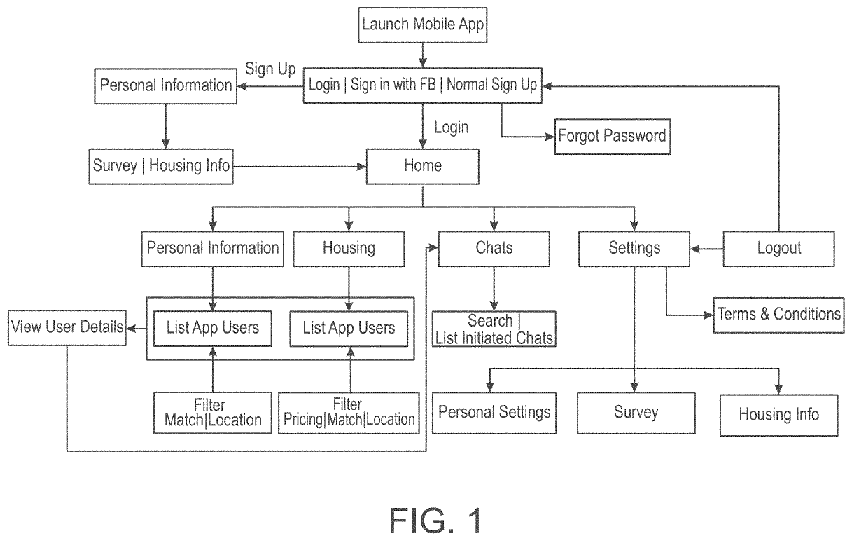

The Friend App is cost-effective to produce in the embodiments, as shown in FIG. 1.

The systems and techniques described herein can be realized or achieved in a number of ways, including digital electronic circuitry, application specific integrated circuits (ASICs), smartphone software, hardware, firmware, or any combination of the above. These various implementations of the claimed systems and techniques can be achieved through one or more computer programs, generally known as software, programs, software applications, and/or code.

The software can be implemented on a programmable system that includes one or more input devices, such as a smartphone, coupled to transmit and receive data from at least one programmable processor and a storage system. The software includes machine instructions for the programmable processor and the input devices, and can be implemented in any appropriate programming language for the respective specifics of the programmable processor and input devices.

The systems and techniques claimed herein can be implemented using a computing system that includes a front end component, such as a user's smartphone with the Friend App as a graphical user interface that can interact with an implementation of the system and techniques described herein, and a back end component, such as a data server, or a middleware component, such as an application server, or any combination of a front end component with a middleware component and/or a back end component.

The computing system can include client device, such as a user's smartphone, and a server that are remote from each other and interact through a communication network. The client device and server have a relationship by virtue of the software running on the respective devices that creates a client-server relationship with each other.

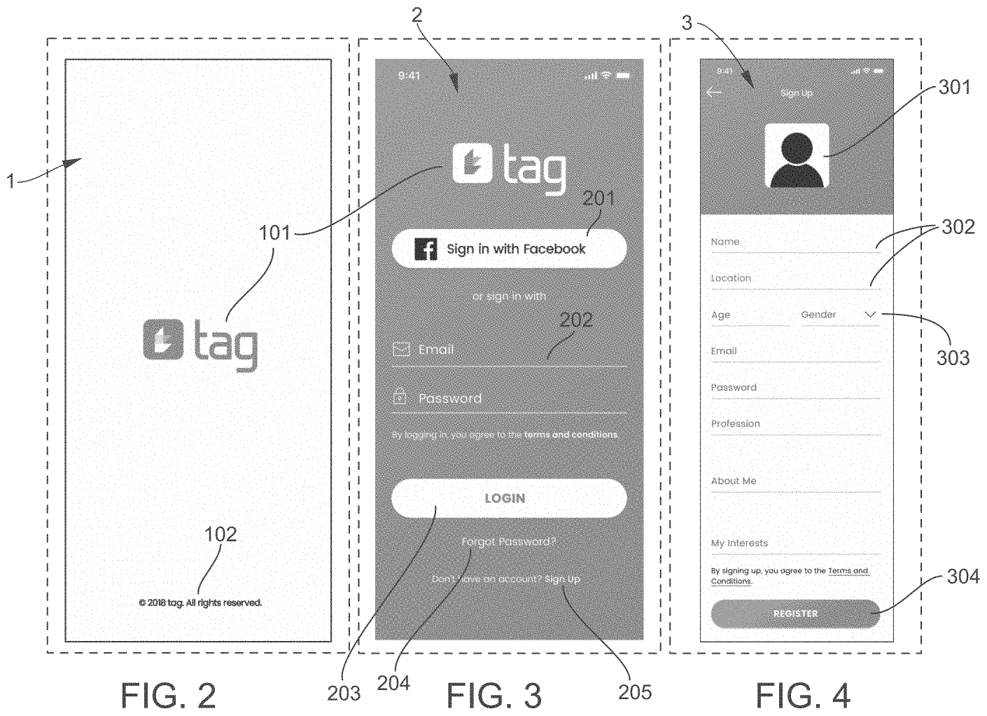

Referring now to the workflow diagram shown in FIG. 1, the algorithm works detailed in the next paragraphs. The launch mobile app step displays the splash screen (1) while the app is loading. As shown in FIG. 2, the splash screen (1) displays the logo (101) and the copyright information (102). The splash screen (1) fades automatically after a few seconds and the login screen (2) is displayed. If the user is already logged in, the splash screen (1) fades to show the home screen (6).

As shown in FIG. 3, the login screen (2) allows the user the option of either logging in, if they already have an account, signing up via Facebook™, or signing up via an email and password. The login screen (2) includes the logo (101), a button for signing in with Facebook™ (201), two text fields to enter a previously registered email address and password (202), a login button (203), a forgot password link (204), and a sign up button (205). If the user selects the sign in with Facebook™ button (201), the Facebook™ login interface appears. Once the user enters their Facebook™ credentials and logs in, the home screen (6) is displayed. If the user enters their registered information into the text fields (202) and clicks the login button (203), the home screen (6) is displayed. If the user selects the sign up option, the sign up screen (3) is displayed.

As shown in FIG. 4, the sign up screen (3) includes a visual element for the user's photo (301), and a number of text fields (302) or drop boxes (303) where the user enter information including name, location, age, gender, email, password, profession, a few words about themselves, a list of their interests, and so on, and a register button (304). After the user fills in the sign up information (302, 303) and clicks the register button (304), the one or more survey screen(s) (4) are displayed in sequence.

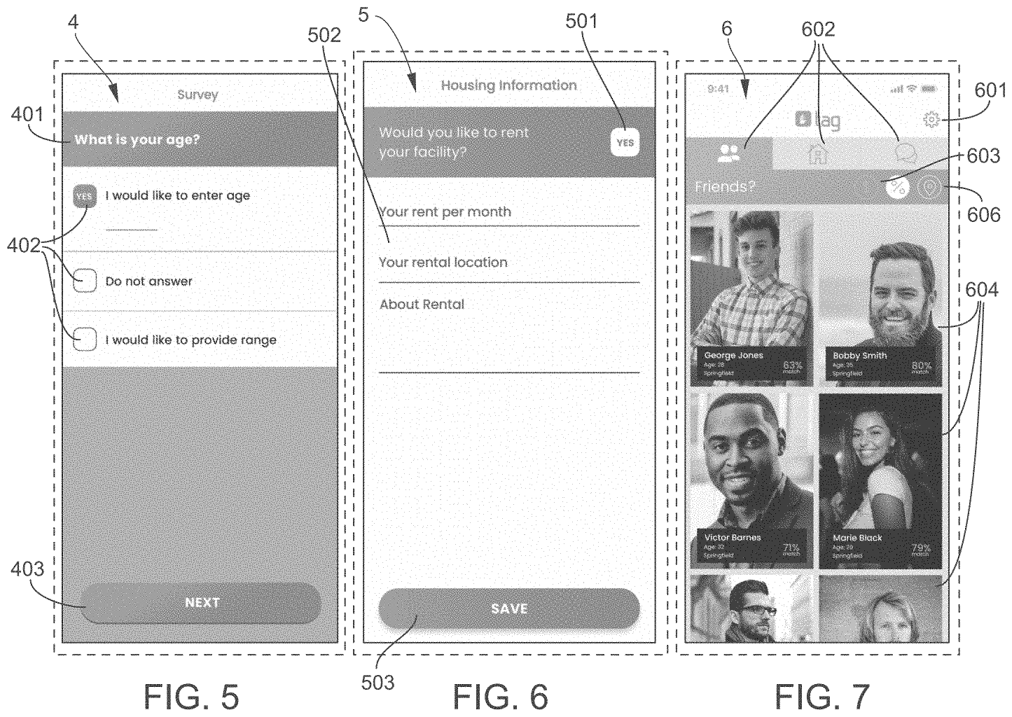

As shown in FIG. 5, the one or more survey screen(s) (4) include a series of survey questions (401), such as the age of the user, and provides a number of options via text or check boxes for response (402), such as a check box to enter an age, and a text box to enter the age into, a check box for do not answer, or a check box for provide an age range, and a text box to enter the age range in. The survey screen(s) contain either a next button (403) to move to the next survey screen, or a save/complete button to finish the survey. The survey screen(s) collect information regarding the user's interests and activities in order to find the best profile matches from amongst the other users. The questions and answer options in the survey screen(s) may be updated periodically in response to user feedback. After the survey screen(s) have been completed, the housing information screen (5) is displayed.

As shown in FIG. 6, the housing information screen (5) includes options such as a question regarding whether the user wants to rent out their housing facility, with a checkbox for yes/no (501), a text field (502) for the user to enter information such as monthly rent, location, and additional information about the rental, and a save button (503). After the housing information screen (5) information is entered, the home screen (6) is displayed.

As shown in FIG. 7, the home screen (6) has a settings icon button (601), three tabs (602) to access each of the friends page (7), housing page (8), and chat page (10). The friends page (7) is the default tab, and has icons to sort friends by rent (603), matching percentage (605) and location (606). The rent icon (603) is disabled for the friends page. The friends page (7) is sorted by matching percentage by default. Each friend (604) listed on the friends page (7) is shown by profile picture with details such as name, age, location, and percentage match below. When a friend (604) is clicked on, that user's profile page (9) is displayed. When the settings icon button (601) is selected, the settings page (12) is displayed.

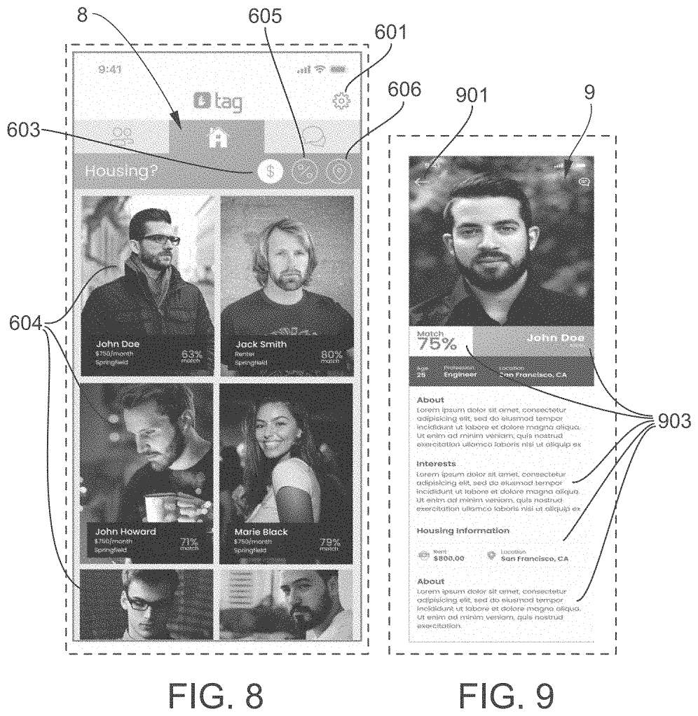

As shown in FIG. 8, the housing tab (8) of the home screen (6) has icons to sort friends by rent (603), matching percentage (605), and location (606). By default, friends are sorted by rent (603) on the housing page (8). Each of the friends (604) listed on the housing tab (8) is shown by profile picture with details such as name, rent, age, location, and percentage match below. When a friend (604) is clicked on, that user's profile page (9) is displayed.

As shown in FIG. 9, a user's profile page (9) includes a return icon (901) for returning to the previous screen, a chat icon (902) for displaying the chat page (10), and text fields (903) with all of the information the user has chosen to display in their profile, including but not limited to their profile picture, percentage match, name, gender, age, profession, location, information on user and user interests, and housing information. Tapping the chat icon (902) displays the chat screen (11).

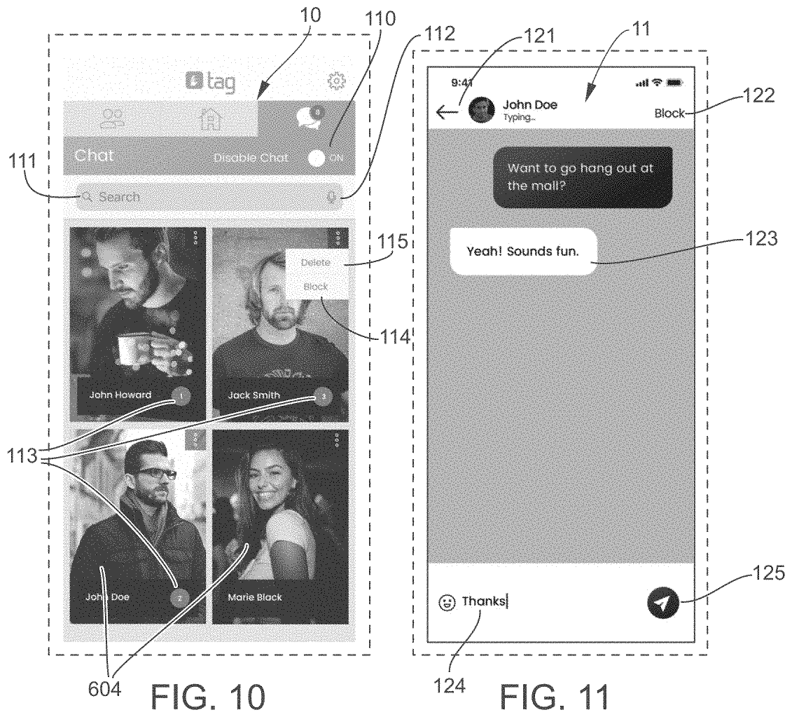

As shown in FIG. 10, the chat page (10) has a toggle button (110) for turning the chat function on and off. By default, the toggle button (110) is off. The chat page (10) also has a search icon and text field (111) and a microphone icon (112). Users can search for other users by name, location, profession, and interests. Tapping the microphone icon (112) allows users to say the search keyword rather than type it in. Matching results of friends (604) are displayed below the search icon and text field (111). The list of friends (604) is sorted so that previously initiated chats are at the top. The number of unread messages is displayed in an unread message icon (113) on each respective user's profile picture (604). A user can block or delete a chat thread by swiping left on the respective row and tapping the block button (114) or the delete button (115). The delete button (115) may be followed by an ok button or a cancel button as an additional check. Selected one of the friends (604) in the list on the chat page (10) displays the chat screen (11).

As shown in FIG. 11, the chat screen (11) has a return icon (121) to return to the previous screen, a block icon (122) to block the other user in the chat screen, and text block (123) that displays the users' chat threads, a text box (124) for entering new messages, and a send button (125) to send the user's message once it is complete in the text box (124).

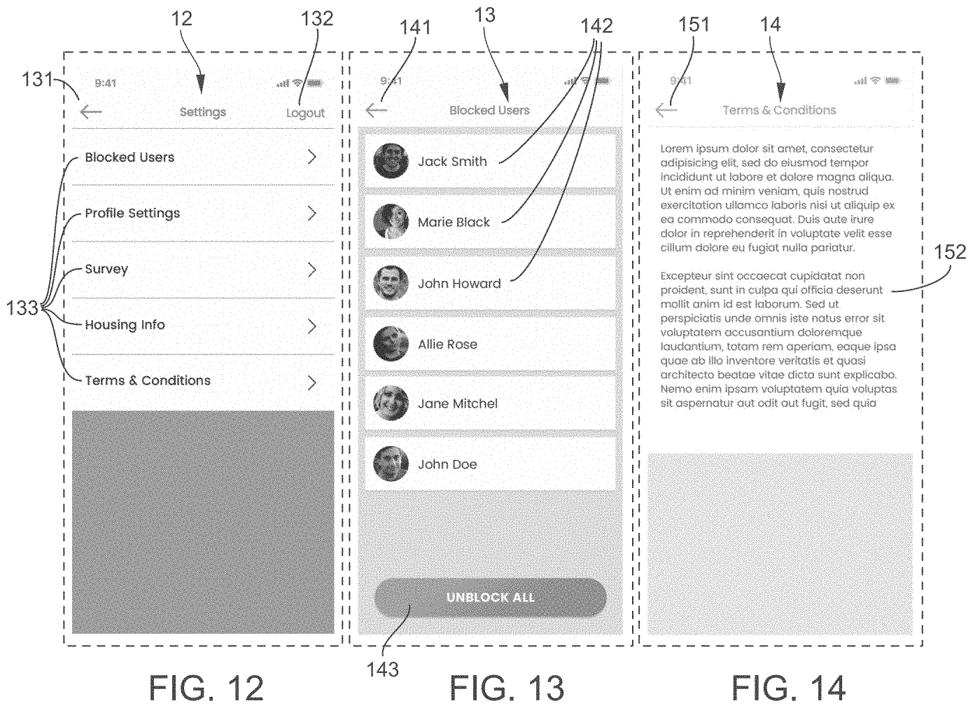

As shown in FIG. 12, the settings page (12) has a return icon (131) to return to the previous screen, a logout button (132) to log the user out of the app, and a list of expandable options (133) including options such as blocked users, profile settings, survey, housing info, and terms and conditions. Selecting the blocked users row displays the blocked users page (13). Selecting the profile settings row displays a page similar to the registration page (3) that allows the user to edit the information entered during registration. Selecting the survey row displays a page similar to the survey screen(s) (4) that allows the user to edit or view their submitted survey. Selecting the housing info row displays a screen similar to the housing information page (5) that allows the user to edit or view their entered housing information. If the terms and condition row is selected, the terms and condition page (14) is displayed.

As shown in FIG. 13, the blocked user page (13) has a return icon (141) to return to the previous screen, a list of blocked users (142), and an unblock all button (143) that will unblock all currently blocked users if selected. A user can unblock a currently blocked user by swiping left on the user's name in the list (142).

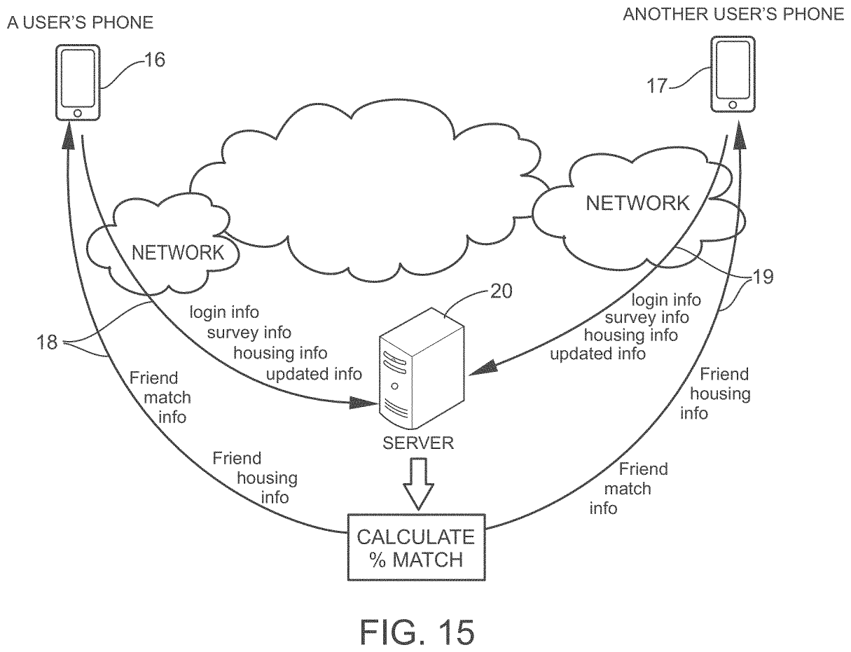

As shown in FIG. 14, the terms and conditions page (14) has a return icon (151) to return to the previous screen and a text section (152) that displays the terms and conditions.

As shown in FIG. 15, the user's information, including login, survey, and housing information, is collected by the Friend App on each user's phone (16, 17) as shown in the flow chart in FIG. 1. The information is then sent by the user's selected cellular or other wireless network (18, 19) to one or more centralized servers (20). The matching algorithm is performed on a middle end component or a back end component or a combination of a middle end component and a back end component (20), as outlined in the flow chart in FIG. 1. The resulting match percentages are sent back to the user's phones (16, 17) over the user's network (18, 19), which can be a cellular network, wireless network, and/or the Internet. When a chat is initiated, the user's message is sent from his or her phone (16) over the network (18) to the centralized server (20), and from the server (20) to the respective other user's phone (17) over his or her network (19).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. Additionally, the logic flows depicted in the figures do not require the specific order shown to achieved the desired object. Additional steps may be added, or steps may be removed, from the described flows, and other components added or removed, from the described systems, creating different implementations that are within the scope of the following claims.

What is claimed is new and desired to be protected by Letters Patent is set forth in the appended claim:

1. A method performed by one or more processing devices, the method comprising the steps of:
a. displaying a graphical interface to a user via a first processing device;
b. requesting personal information from the user via the graphical interface;
c. in response to the request, receiving the requested personal information from the user;
d. storing the received personal information on a storage device;
e. analyzing the stored personal information with other user's received personal information via a second processing device;
f. adding the stored personal information to a list of other user's in a specific geographical location;
g. determining the possible compatibility of the user's personal information with respect to other users in the specific geographical location's stored personal information by comparing the analysis of each user's stored personal information via the second processing device;
h. ranking the compatibility of two user's stored personal information as a percentage via the second processing device;
i. presenting the results of the ranking to the user as a list of other users and the user's percentage compatibility with each other user via the graphical interface on the first processing device; and
j. presenting the stored personal information of other users on the list of compatible users to the user upon request.

2. The method according to claim 1, wherein the personal information is requested from the user by an updateable survey that is executable on the first processing device via the graphical interface.

3. The method according to claim 1, wherein the requested personal information is information regarding the user's location, interests, hobbies, activities, housing availability, and rental rate.

4. The method according to claim 3, wherein the compatibility of two users is determined based on each user's interests, hobbies, and activities.

5. The method according to claim 3, wherein the compatibility of two users is determined based on each user's housing availability and rental rate.

6. The method according to claim 1, the method comprising the additional step of:
a. providing a login process, wherein the user can access and alter the user's stored personal information once the login process is complete.

7. The method according to claim 1, wherein the method comprises the additional steps of:
a. storing one or more text messages entered by the user via the graphical interface on the first processing device;
b. sending the text messages to the second processing device via a network connection between the first processing device and the second processing device;
c. identifying which user is an intended recipient of the text message via the second processing device;
d. sending the text messages to the intended recipient user via a second graphical interface on a third processing device;
e. receiving text messages on the first processing device from the second processing device via the network connection; and
f. providing a visual representation of messages to and from another user via the graphical interface on the first processing device, wherein the visual representation of messages is sorted by individual users.

8. The method according to claim 7, wherein the method comprises the additional step of:
a. presenting the option, upon the user's request, to block text messages from an indicated other user; and
b. in response the user's request, blocking text messages from the indicated other user.

9. One or more storage devices storing instructions that are executable to perform operations comprising:
a. displaying a graphical interface to a user;
b. requesting personal information from the user via the graphical interface;
c. in response to the request, receiving the requested personal information from the user;
d. storing the received personal information;
e. analyzing the stored personal information with other user's received personal information;
f. adding the stored personal information to a list of other user's in a specific geographical location;
g. determining the possible compatibility of the user's personal information with respect to other users in the specific geographical location's stored personal information by comparing the analysis of each user's stored personal information;
h. ranking the compatibility of two user's stored personal information as a percentage;
i. issuing the results of the ranking to the user as a list of other users and the user's percentage compatibility with each other user via the graphical interface; and
j. presenting the stored personal information of other users on the list of compatible users to the user upon request.

10. The one or more storage devices according to claim 9, wherein the instructions are executable to perform additional operations comprising:
a. storing one or more text messages entered by the user;
b. sending the text messages via a network connection;
c. identifying which user is an intended recipient of the text;
d. sending the text messages to the intended recipient user;
e. receiving text messages via the network connection; and
f. providing a visual representation of messages to and from another user via the graphical interface, wherein the visual representation of messages is sorted by individual users.

11. The one or more storage devices according to claim 9, wherein the instructions are executable to perform additional operations comprising:
a. permitting a user to access and alter the user's stored personal information via a login process.

12. The one or more storage devices according to claim 9, wherein the stored personal information is information regarding the user's location, interests, hobbies, activities, housing availability, and rental rate.

13. The one or more storage devices according to claim 12, wherein the compatibility of two users is determined based on each user's stored interests, hobbies, and activities.

14. The one or more storage devices according to claim 12, wherein the compatibility of two users is determined based on each user's stored housing availability and rental rate.

15. A method performed by one or more processing devices, the method comprising the steps of:
a. displaying a graphical interface to a user via a first processing device;
b. requesting personal information from the user via the graphical interface, wherein the personal information is requested from the user by an updateable survey that is executable on the first processing device via the graphical interface, and wherein the requested personal information is information regarding the user's location, interests, hobbies, activities, housing availability, and rental rate;
c. in response to the request, receiving the requested personal information from the user;
d. storing the received personal information on a storage device;
e. providing a login process, wherein the user can access and alter the user's stored personal information once the login process is complete;
f. analyzing the stored personal information with other user's received personal information via a second processing device;
g. adding the stored personal information to a list of other user's in a specific geographical location;
h. determining the possible compatibility of the user's personal information with respect to other users in the specific geographical location's stored personal information by comparing the analysis of each user's stored personal information via the second processing device;
i. ranking the compatibility of two user's stored personal information as a percentage via the second processing device;
j. presenting the results of the ranking to the user as a list of other users and the user's percentage compatibility with each other user via the graphical interface on the first processing device;
k. presenting the stored personal information of other users on the list of compatible users to the user upon request;
l. storing one or more text messages entered by the user via the graphical interface on the first processing device;
m. sending the text messages to the second processing device via a network connection between the first processing device and the second processing device;
n. identifying which user is an intended recipient of the text message via the second processing device;
o. sending the text messages to the intended recipient user via a second graphical interface on a third processing device;
p. receiving text messages on the first processing device from the second processing device via the network connection; and
q. providing a visual representation of messages to and from another user via the graphical interface on the first processing device, wherein the visual representation of messages is sorted by individual users;
r. presenting the option, upon the user's request, to block text messages from an indicated other user; and
s. in response the user's request, blocking text messages from the indicated other user.

16. The method according to claim 15, wherein the compatibility of two users is determined based on each user's interests, hobbies, and activities.

17. The method according to claim 15, wherein the compatibility of two users is determined based on each user's housing availability and rental rate.
